(19) United States
(12) Patent Application Publication
(10) Pub. No.: US 2014/0025445 A1
(43) Pub. Date: Jan. 23, 2014

(54) METHOD AND SYSTEM FOR ON DEMAND DAILY DEAL SETTLEMENT

(71) Applicants: Jose-Luis Celorio MARTINEZ, New York, NY (US); Andrea Christine Gilman, Chappaqua, NY (US); Dana Marie Kuo, New York, NY (US)

(72) Inventors: Jose-Luis Celorio MARTINEZ, New York, NY (US); Andrea Christine Gilman, Chappaqua, NY (US); Dana Marie Kuo, New York, NY (US)

(73) Assignee: MasterCard International Incorporated, Purchase, NY (US)

(21) Appl. No.: 13/551,406

(22) Filed: Jul. 17, 2012

(51) Int. Cl. G06Q 20/38

(52) U.S. Cl. CPC G06Q 20/387
USPC 705/14.1

(57) ABSTRACT

A method for initiating and processing a financial transaction includes: receiving and accumulating the value of one or more deal redemptions; receiving, by a receiving device, a request for payment, wherein the request for payment includes at least a merchant identifier, a payer identifier, and a transaction amount; identifying, by a processing device, a controlled payment number, wherein the controlled payment number is restricted to a merchant corresponding to the merchant identifier and the transaction amount; initiating a financial transaction for the transaction amount between a payer corresponding to the payer identifier and the merchant, wherein the controlled payment number is used for the payment of the financial transaction; and processing, by the processing device, the financial transaction.

### FIELD

The present disclosure relates to the on demand settlement of daily deals redeemed at a merchant, specifically initiating and processing financial transactions between the merchant and a deal provider on demand by the merchant.

### BACKGROUND

As consumers become more and more concerned with sales and coupons and discounts, a new industry has merged in acting as a middleman to provide deals for consumers. In many instances, these deal providers sell deals to consumers, who are then free to redeem the deal at a corresponding merchant at an even greater discount. For example, the consumer may purchase a deal from a deal provider for $20, the deal allowing the consumer to get $40 of services or products in their next purchase at the merchant.

In order to recover losses from these discounted purchases, deal providers and merchants often have an agreement that, for each deal that is redeemed, the deal provider reimburses the merchant for at least a portion of the discount. Methods for redeeming and settlement of daily deals can be found in U.S. Provisional Patent Application No. 61/586,049, filed Jan. 12, 2012, herein incorporated by reference in its entirety. Many deal providers wait until a significant number of deals have been redeemed before settling with the merchant, in order to reduce costs and processing time. Even with aggregation of deals prior to settling, the process can present a technical problem in that it can be both time consuming and expensive for the deal provider particularly where the process has to be conducted by humans and a check issued, and may also delay receipt of payment for the merchant.

Thus, there is a need for a more efficient technology-based system for initiating and processing financial transactions to settle deal redemptions that uses controlled payment numbers and the exact settlement amount for on-demand and secure settlement.

### SUMMARY

The present disclosure provides a description of a system and method for on demand daily deal settlement by initiating and processing a financial transaction.

A method for initiating and processing a financial transaction includes: receiving and accumulating the value of one or more deal redemptions; receiving, by a receiving device, a request for payment, wherein the request for payment includes at least a merchant identifier, a payer identifier, and a transaction amount; identifying, by a processing device, a controlled payment number, wherein the controlled payment number is restricted to a payee and the transaction amount; initiating a financial transaction for the transaction amount between a payer corresponding to the payer identifier and the payee, wherein the controlled payment number is used for the payment of the financial transaction; and processing, by the processing device, the financial transaction.

A system for initiating and processing a financial transaction includes a receiving device and a processing device. The receiving device is configured to receive and accumulate the value of one or more deal redemptions and receive a request for payment, wherein the request for payment includes at least a merchant identifier, a payer identifier, and a transaction amount. The processing device is configured to: provide a controlled payment number, wherein the controlled payment number is restricted to a payee and the transaction amount; initiate a financial transaction for the transaction amount between a payer corresponding to the payer identifier and the payee, wherein the controlled payment number is used for the payment of the financial transaction; and process the financial transaction.

### BRIEF DESCRIPTION OF THE DRAWING FIGURES

Exemplary embodiments are best understood from the following detailed description when read in conjunction with the accompanying drawings. Included in the drawings are the following figures:

FIG. 1 is a block diagram illustrating a system for on demand daily deal settlement in accordance with exemplary embodiments.

FIG. 2 is a block diagram illustrating a financial transaction processing server in accordance with exemplary embodiments.

FIG. 3 is a diagram illustrating a graphical user interface for on demand settlement of daily deal redemptions in accordance with exemplary embodiments.

FIG. 4 is a flow diagram illustrating a method for on demand daily deal settlement in accordance with exemplary embodiments.

FIG. 5 is a block diagram illustrating system architecture of a computer system in accordance with exemplary embodiments.

FIG. 6 is a flow chart illustrating an exemplary method for initiating and processing a financial transaction in accordance with exemplary embodiments.

Further areas of applicability of the present disclosure will become apparent from the detailed description provided hereinafter. It should be understood that the detailed description of exemplary embodiments are intended for illustration purposes only and are, therefore, not intended to necessarily limit the scope of the disclosure.

### DETAILED DESCRIPTION

### System for On Demand Daily Deal Settlement

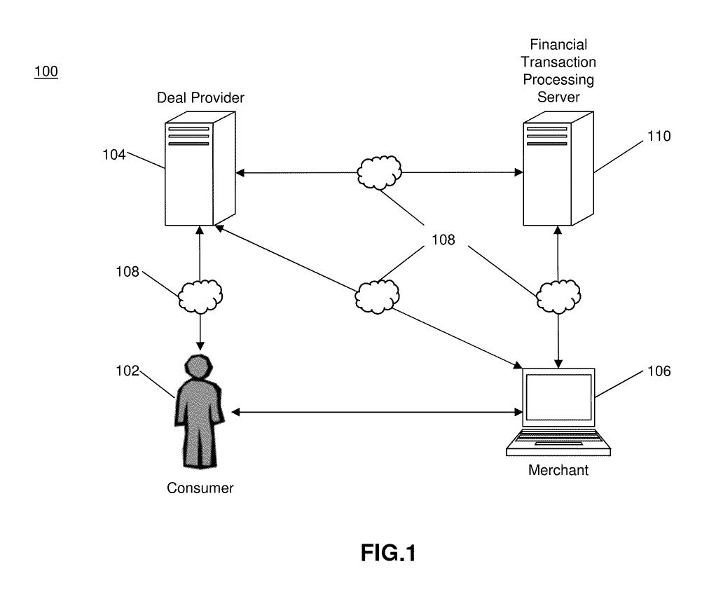

FIG. 1 illustrates a system 100 for processing a reservation and approving and processing a financial transaction. Several of the components of the system 100 may communicate via a network 108. The network 108 may be any network suitable for performing the functions as disclosed herein and may include a local area network (LAN), a wide area network (WAN), a wireless network (e.g., WiFi), a mobile communication network, a satellite network, the Internet, fiber optic, coaxial cable, infrared, radio frequency (RF), or any combination thereof. Other suitable network types and configurations will be apparent to persons having skill in the relevant art.

The system 100 may include a consumer 102. The consumer 102 may obtain (e.g., purchase) a deal from a deal provider 104. The deal may be any type of sale, discount, etc. on goods or services available from a merchant 106. Types of deals suitable for use in the systems and methods as disclosed herein will be apparent to persons having skill in the relevant art.

The consumer 102 may visit the merchant 106 (e.g., at a physical location, via a webpage, etc.) and purchase goods or services. The consumer 102 may provide proof of the obtained deal to the merchant 106 in order to obtain the corresponding deal. In some embodiments, the consumer 102 may provide proof by showing a physical coupon or other indication of purchase. In other embodiments, the deal provider 104 may provide information on the consumer 102, which may be verified by the consumer 102 in order to authenticate the deal. Other methods for redemption of the deal by the consumer 102 will be apparent to persons having skill in the relevant art.

The merchant 106 may process redemption of the deal using a point-of-sale (POS) system and may initiate and conduct the financial transaction by transmitting an authorization request for the financial transaction to a financial transaction processing server 110. The financial transaction processing server 110 may process the transaction and notify the merchant 106 if the transaction is approved. If the transaction is approved, the merchant 110 may finalize the transaction and notify the deal provider 104 of the redemption by the consumer 102. In some embodiments, the financial transaction processing server 110 may notify the deal provider 104 of the redemption by the consumer 102 (e.g., using a unique identifier associated with the coupon).

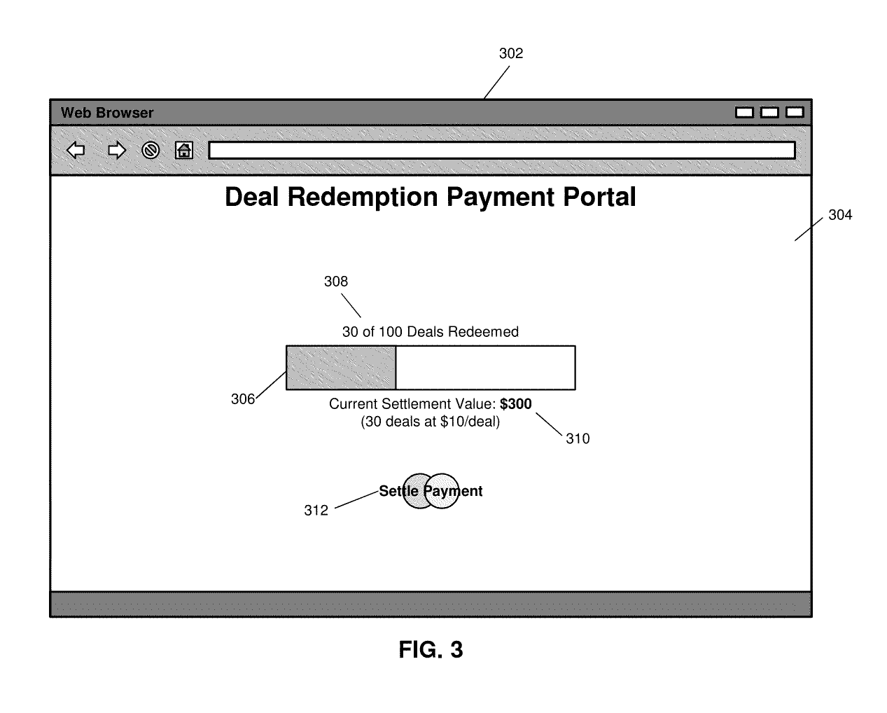

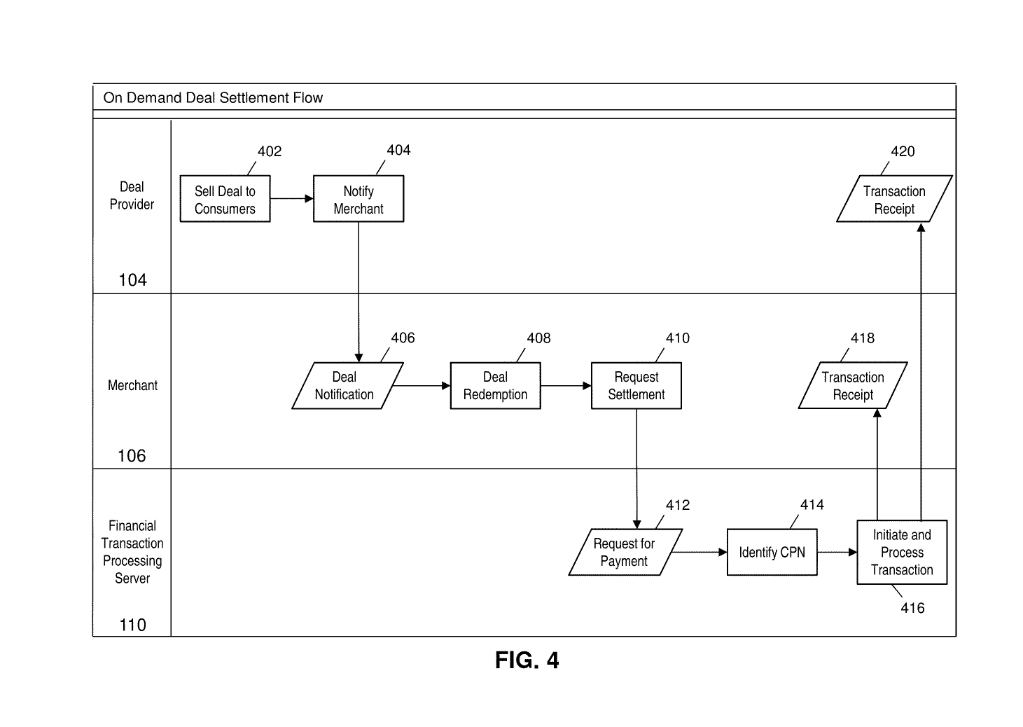

The financial transaction processing server 110 (e.g., or the merchant 106 or deal provider 104) may monitor and/or track each redemption made for a deal provided by the deal provider 104, or the deal provider 104 may report the redemptions for purposes of paying the merchant 106. Either way, the financial transaction processing server 110 may receive the information and aggregate the value of one or more redeemed deals (e.g., or receive the aggregated value). The merchant 106 may request payment for redeemed deals by submitting a request for payment to the financial transaction processing server 110. In some embodiments, the merchant 106 may submit the request through a web page associated with the financial transaction processing server 110, as discussed in more detail below with reference to FIGS. 3 and 4. The financial transaction processing server 110 may receive the request for payment and process the request by initiating and processing a financial transaction between the merchant 106 (e.g., or a third party) and the deal provider 104 for an amount corresponding to the number of redeemed deals, such as by using the method of FIG. 4, discussed in more detail below.

In an exemplary embodiment, the financial transaction processing server 110 may use a controlled payment number to charge for the financial transaction. A controlled payment number may be a unique payment card number identified and used for a single transaction. The controlled payment number may be associated with payment card use conditions, such as conditions that it only be used for a transaction including a specific payer (e.g., the deal provider 104) and for a specific amount (e.g., the amount corresponding to the number of redeemed deals). Further details regarding controlled payment numbers can be found in U.S. Pat. Nos. 6,315,193; 6,793,131; 7,136,835; 7,593,896; 7,571,142; 7,567,934; 7,895,122; 8,229,854; and, in particular, U.S. Pat. No. 7,433,845 (“Data structure, method and system for generating person-to-person, person-to-business, business-to-person, and business-to-business financial transactions”) U.S. application Ser. No. 10/914,766, filed on Aug. 9, 2004; U.S. application Ser. No. 11/560,212, filed on Nov. 15, 2006; U.S. application Ser. No. 12/219,952, filed on Jul. 30, 2008; and International Application No. PCT/US2009/005029, filed on Sep. 19, 2009, U.S. Published Patent Application No. 2009/0037333, filed on Jul. 30, 2008, all incorporated herein by reference in their entirety (herein the controlled payment numbers or CPN Patents).

### Financial Transaction Processing Server

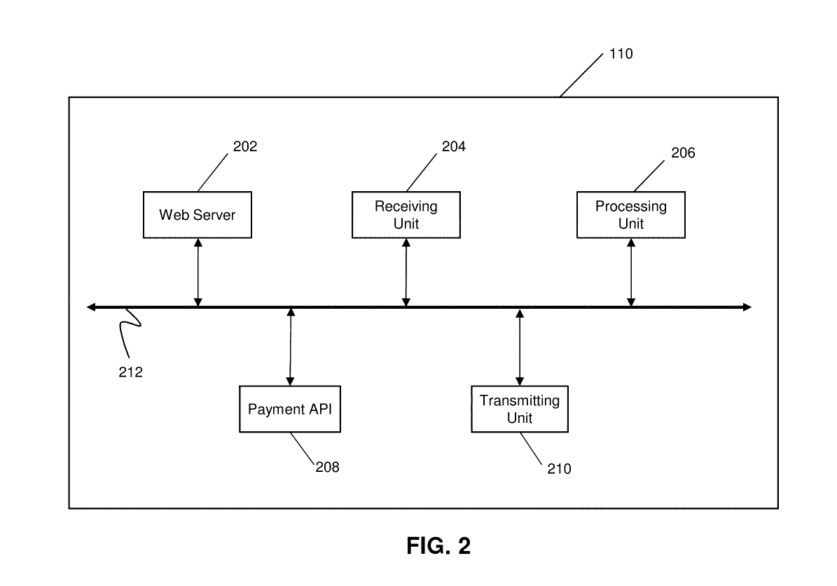

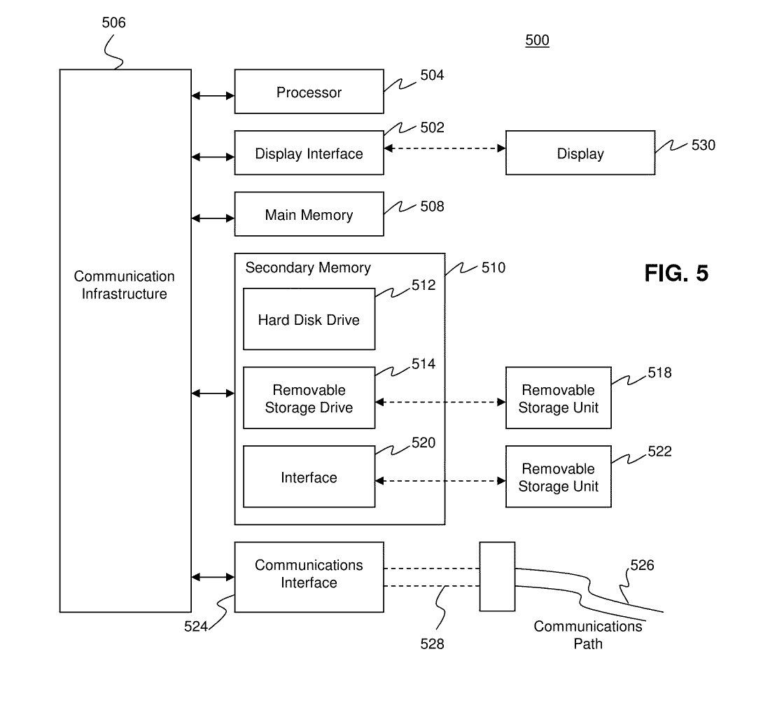

FIG. 2 illustrates an embodiment of the financial transaction processing server 110. The financial transaction processing server 110 may be any kind of server configured to perform the functions as disclosed herein, such as the computer system illustrated in FIG. 5 and described in more detail below. The financial transaction processing server 110 may include a receiving unit 204, a processing unit 206, a payment application programming interface (API) 208, and a transmitting unit 210. Each of the components may be connected via a bus 212. Suitable types and configurations of the bus 212 will be apparent to persons having skill in the relevant art.

In some embodiments, the financial transaction processing server 110 may include a web server 202. The web server 202 may be configured to host a web page, which may be programmed such that the merchant 106 may submit a request for payment to the financial transaction processing server 110. It will be apparent to persons having skill in the relevant art that the web page may be hosted by a web server external to the financial transaction processing server 110. For example, the web page may be hosted by a third party web server on behalf of the financial transaction processing server 110, or may be hosted by or on behalf of the deal provider 104.

The receiving unit 204 may be configured to receive a request for payment (e.g., from the merchant 106). The request for payment may include at least a merchant identifier (e.g., corresponding to the merchant 106), a payer identifier (e.g., corresponding to the deal provider 104), and a transaction amount (e.g., corresponding to the number of deals redeemed since last payment). The processing unit 206 may be configured to identify a controlled payment number, which may be associated with the deal provider 104 and may include a condition such that it can only be used for a transaction of the received transaction amount. It should be noted that the functions of providing merchant payment and providing controlled payment numbers can be separated, either on different servers or even by different business entities, as appropriate under given circumstances.

The payment API 208 may be configured to initiate a financial transaction between the merchant 106 and the deal provider 104 using at least the controlled payment number and the transaction amount. The processing unit 206 may be configured to process the financial transaction. The transmitting unit 210 may be configured to transmit a response to the authorization request and/or the request for payment to the merchant 106. In some embodiments the transmitting unit 210 may be configured to transmit a notification of redemption to the merchant 106 and/or the deal provider 104.

In other embodiments, the processing unit 206 may be configured to track the number of redemptions of a deal. In a further embodiment, the processing unit 206 may be configured to store the redemption information in a redemption database. The redemption database may be any type of database suitable for the storage of redemption information as will be apparent to persons having skill in the relevant art. The redemption database may be included as part of the financial transaction processing server 110 or may be external to the financial transaction processing server 110 (e.g., and accessed via the network 108). The redemption database may be a single database or may be multiple databases interfaced together (e.g., physically or via a network, such as the network 108).

### Graphical User Interface

FIG. 3 illustrates a simple exemplary graphical user interface of a web browser 302. The web browser 302 may display a web page 304 to a user (e.g., the merchant 106). In one embodiment, the web page 304 may be hosted by the web server 202 of the financial transaction processing server 110, or of a third party (e.g., by or on behalf of the deal provider 104). In some embodiments, the web page 304 may be hosted and/or operated by the deal provider 104, but may display content or information provided by the financial transaction processing server 110, such as the information illustrated in the web page 304 illustrated in FIG. 3. For example, the merchant 106 may navigate to the web page 304 at a web site hosted and/or operated by the deal provider 304, while the information related to deal redemption and submitting a request for payment may be provided by the financial transaction processing server 110, such as through an application programming interface (API).

The web page 304 may be a web page programmed to display to the merchant 106 information relating to redeemed deals and may enable the merchant 106 to submit a request for payment. The web page 304 may include a number of redeemed deals 308. The web page 304 may also include a progress bar 306 that may graphically illustrate the number of redeemed deals 308, such as by showing what percentage of deals of the total number of deals have been redeemed, as illustrated in FIG. 3. The web page 304 may also include a redemption amount 310. The redemption amount 310 may be the amount of owed to the merchant 106 by the deal provider 104 based on the number of redeemed deals 308. For example, as illustrated in FIG. 3, each deal redeemed may cost the deal provider $10 to be paid to the merchant.

The web page 304 may also include a button 312. The button 312 may be configured to submit a request for payment (e.g., to the financial transaction processing server 110) when interacted with by the merchant 106. In the example illustrated in FIG. 3, the request for payment submitted by the web page 304 would be a request for payment of $300 by the deal provider 104 to the merchant 106 in recognition of 30 redeemed deals. More complicated web pages 304 may show more information about the deal program, such as reporting the number of unredeemed deals, and other statistical and/or numerical information, etc.

### Method for On Demand Daily Deal Settlement

FIG. 4 illustrates a method for the on demand settlement of daily deal redemptions.

In step 402, the deal provider 104 may provide (e.g., sell) deals to consumers (e.g., the consumer 102). The deal may be any discount, sale, etc. associated with a merchant (e.g., the merchant 106) for the purchase of goods or services. In step 404, the deal provider 104 may notify the merchant 106 of the deal purchased by the consumer 102. In one embodiment, notification may include unique identification of a deal. For example, the notification may include the name of the consumer 102 for verification by the consumer 102 upon redemption. Suitable information included in the notification to the merchant 106 will be apparent to persons having skill in the relevant art.

In step 406 the merchant 106 may receive (e.g., and store) the received notification of the deal. Then, in step 408, the consumer 102 may redeem the deal with the merchant 106. The merchant 106 may process a financial transaction between the consumer 102 and the merchant 106. In some embodiments, the merchant 106 (e.g., or the financial transaction processing server 110) may notify the deal provider 104 of the redemption. In one embodiment, the financial transaction processing server 110 may track the redemptions of the deal. In another embodiment, the merchant 106 may track the redemptions of the deal.

In step 410, the merchant 106 may (e.g., via the web page 304) request settlement on the redemptions by submitting to the financial transaction processing server 110 a request for payment. The financial transaction processing server 110 may receive the request for payment in step 412. The request for payment may include at least a merchant identifier (e.g., corresponding to the merchant 106), a payer identifier (e.g., corresponding to the deal provider 104), and a transaction amount (e.g., the redemption amount 310).

In step 414, the financial transaction processing server 110 may identify a controlled payment number. In one embodiment the controlled payment number may be associated with at least two payment card use conditions. In a further embodiment, the payment card use conditions may be a required merchant (e.g., the merchant 106) or another authorized recipient (such that the generated controlled payment number can be used to convey money to another entity selected by the merchant), and a required transaction amount (e.g., the redemption amount 310). For example, the another authorized recipient may be an entity related to the redeemed deal, such as a distributor, a retailer, or a manufacturer. In some embodiments, the merchant 106 may (e.g., via the request for payment) identify the payee. In further embodiments, the merchant 106 may also request that only a portion of the transaction amount be paid to the payee authorized recipient (e.g., 20% of the proceeds to the manufacturer).

Then, in step 416, the financial transaction processing server 110 may initiate (e.g., using the payment API 208) and process a financial transaction between the merchant 106 and the deal provider 104, with the transaction being charged to the identified controlled payment number. After the transaction has been processed, the merchant 106 and the deal provider 104 may each receive a receipt (e.g., a notification) of the transaction in steps 418 and 420. The merchant 106 and the deal provider 104 may finalize the transaction (e.g., by providing the purchased goods or services to the deal provider 104).

In some embodiments, the financial transaction processing server 110 may, based on the request for payment, identify multiple controlled payment numbers, each associated with a different payee and transaction amount. For example, the merchant 106 may have a contractual agreement with additional entities regarding the proceeds of the deal redemption. In such an example the merchant 106 may have an agreement that the merchant 106 receive 50% of proceeds, a distributor receive 30% of proceeds, and a manufacturer receive 20% of proceeds. The merchant 106 may communicate the agreement to the financial transaction processing server 110 such that, when a request for payment is submitted by the merchant 106, the financial transaction processing server 110 identifies three controlled payment numbers, each associated with a different entity (e.g., the merchant 106, the distributor, and the manufacturer) and a different transaction amount (e.g., 50% of the redemption amount 310, 30% of the amount 310, and 20% of the amount 310). The financial transaction processing server 110 may initiate three financial transactions for each corresponding controlled payment number such that the proceeds can be properly distributed to each entity per the agreement.

### Computer System Architecture

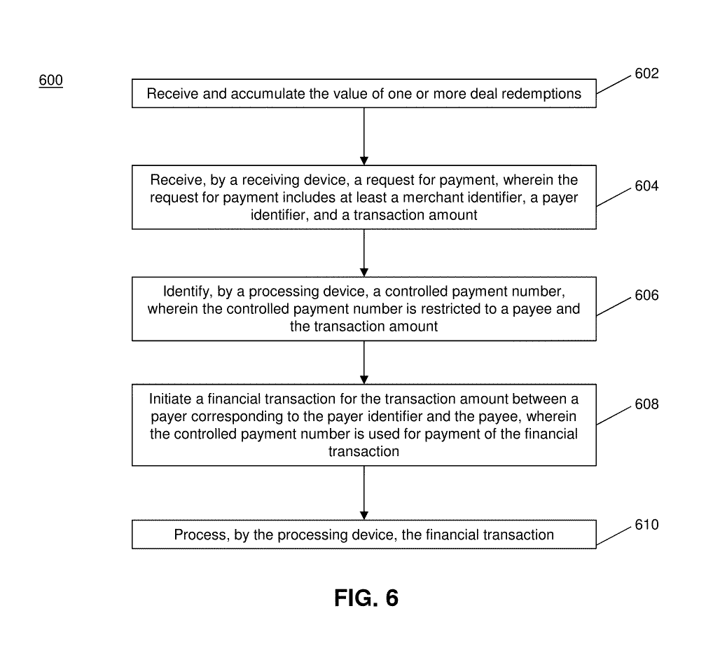

FIG. 5 illustrates a computer system 500 in which embodiments of the present disclosure, or portions thereof, may be implemented as computer-readable code. For example, the deal provider 104, the merchant 106, and the financial transaction processing server 110 of FIG. 1 may be implemented in the computer system 500 using hardware, software, firmware, non-transitory computer readable media having instructions stored thereon, or a combination thereof and may be implemented in one or more computer systems or other processing systems. Hardware, software, or any combination thereof may embody modules and components used to implement the methods of FIGS. 4 and 6.

If programmable logic is used, such logic may execute on a commercially available processing platform or a special purpose device. A person having ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor device and a memory may be used to implement the above described embodiments.

A processor device as discussed herein may be a single processor, a plurality of processors, or combinations thereof. Processor devices may have one or more processor “cores.” The terms “computer program medium,” “non-transitory computer readable medium,” and “computer usable medium” as discussed herein are used to generally refer to tangible media such as a removable storage unit 518, a removable storage unit 522, and a hard disk installed in hard disk drive 512.

Various embodiments of the present disclosure are described in terms of this example computer system 500. After reading this description, it will become apparent to a person skilled in the relevant art how to implement the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor device 504 may be a special purpose or a general purpose processor device. The processor device 504 may be connected to a communication infrastructure 506, such as a bus, message queue, network (e.g., the network 108), multi-core message-passing scheme, etc. The computer system 800 may also include a main memory 508 (e.g., random access memory, read-only memory, etc.), and may also include a secondary memory 510. The secondary memory 510 may include the hard disk drive 512 and a removable storage drive 514, such as a floppy disk drive, a magnetic tape drive, an optical disk drive, a flash memory, etc.

The removable storage drive 514 may read from and/or write to the removable storage unit 518 in a well-known manner. The removable storage unit 518 may include a removable storage media that may be read by and written to by the removable storage drive 514. For example, if the removable storage drive 514 is a floppy disk drive, the removable storage unit 518 may be a floppy disk. In one embodiment, the removable storage unit 518 may be non-transitory computer readable recording media.

In some embodiments, the secondary memory 510 may include alternative means for allowing computer programs or other instructions to be loaded into the computer system 500, for example, the removable storage unit 522 and an interface 520. Examples of such means may include a program cartridge and cartridge interface (e.g., as found in video game systems), a removable memory chip (e.g., EEPROM, PROM, etc.) and associated socket, and other removable storage units 522 and interfaces 520 as will be apparent to persons having skill in the relevant art.

The computer system 500 may also include a communications interface 524. The communications interface 524 may be configured to allow software and data to be transferred between the computer system 500 and external devices. Exemplary communications interfaces 524 may include a modem, a network interface (e.g., an Ethernet card), a communications port, a PCMCIA slot and card, etc. Software and data transferred via the communications interface 524 may be in the form of signals, which may be electronic, electromagnetic, optical, or other signals as will be apparent to persons having skill in the relevant art. The signals may travel via a communications path 526, which may be configured to carry the signals and may be implemented using wire, cable, fiber optics, a phone line, a cellular phone link, a radio frequency link, etc.

Computer program medium and computer usable medium may refer to memories, such as the main memory 508 and secondary memory 510, which may be memory semiconductors (e.g. DRAMs, etc.). These computer program products may be means for providing software to the computer system 500. Computer programs (e.g., computer control logic) may be stored in the main memory 508 and/or the secondary memory 510. Computer programs may also be received via the communications interface 524. Such computer programs, when executed, may enable computer system 500 to implement the present methods as discussed herein. In particular, the computer programs, when executed, may enable processor device 504 to implement the methods illustrated by FIGS. 4 and 6, as discussed herein. Accordingly, such computer programs may represent controllers of the computer system 500. Where the present disclosure is implemented using software, the software may be stored in a computer program product and loaded into the computer system 500 using the removable storage drive 514, interface 520, and hard disk drive 512, or communications interface 524.

### Exemplary Method for Initiating and Processing a Financial Transaction

FIG. 6 illustrates a method 600 for initiating and processing a financial transaction.

In step 602, the value of one or more deal redemptions may be received (e.g., by the receiving unit 204) and accumulated (e.g., by the processing unit 206).

In one embodiment, the received value may be the accumulated value. In step 604, a request for payment may be received by a receiving device (e.g., the receiving unit 204), wherein the request for payment includes at least a merchant identifier, a payer identifier, and a transaction amount (e.g., the redemption amount 310). In one embodiment, the transaction amount may be the accumulated value of the one or more deal redemptions. In one embodiment, the payer identifier may be an account number for a financial account. In a further embodiment, the controlled payment number may be associated with the financial account. In an alternative or additional further embodiment, the financial account may be associated with a deal provider (e.g., the deal provider 104) that provides a deal corresponding to the one or more deal redemptions.

Then, in step 606, a controlled payment number may be identified by a processing device (e.g., the processing unit 206), wherein the controlled payment number is restricted to a payee and the transaction amount. In one embodiment, the payee may be the merchant (e.g., the merchant 106) corresponding to the merchant identifier. In another embodiment, the payee may be an entity related to a deal corresponding to the one or more deal redemptions. In a further embodiment, the entity may be at least one of a distributor, a retailer, and a manufacturer. In step 608, a financial transaction for the transaction amount between a payer (e.g., the deal provider 104) corresponding to the payer identifier and the merchant 106 may be initiated, wherein the controlled payment number is used for payment of the financial transaction. In step 610, the financial transaction may be processed by the processing unit 206.

Techniques consistent with the present disclosure provide, among other features, systems and methods for on demand daily deal settlement including the initiating and processing of financial transactions. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope.

What is claimed is:

1. A method for initiating and processing a financial transaction, comprising:
receiving and accumulating the value of one or more deal redemptions;
receiving, by a receiving device, a request for payment, wherein the request for payment includes at least a merchant identifier, a payer identifier, and a transaction amount;
identifying, by a processing device, a controlled payment number, wherein the controlled payment number is restricted to a payee and the transaction amount;
initiating a financial transaction for the transaction amount between a payer corresponding to the payer identifier and the payee, wherein the controlled payment number is used for payment of the financial transaction; and
processing, by the processing device, the financial transaction.

2. The method of claim 1, wherein the payer identifier is an account number for a financial account.

3. The method of claim 2, wherein the controlled payment number is associated with the financial account.

4. The method of claim 2, wherein the financial account is associated with a deal provider that provides a deal corresponding to the one or more deal redemptions.

5. The method of claim 1, wherein the payee is a merchant corresponding to the merchant identifier.

6. The method of claim 1, wherein the payee is an entity related to a deal corresponding to the one or more deal redemptions.

7. The method of claim 6, wherein the entity is at least one of a distributor, a retailer, and a manufacturer.

8. A system for initiating and processing a financial transaction, comprising:
a receiving device configured to
receive and accumulate the value of one or more deal redemptions, and
receive a request for payment, wherein the request for payment includes at least a merchant identifier, a payer identifier, and a transaction amount; and
a processing device configured to
identify a controlled payment number, wherein the controlled payment number is restricted to a payee and the transaction amount,
initiate a financial transaction for the transaction amount between a payer corresponding to the payer identifier and the payee, wherein the controlled payment number is used for payment of the financial transaction, and
processing the financial transaction.

9. The system of claim 8, wherein the payer identifier is an account number for a financial account.

10. The system of claim 9, wherein the controlled payment number is associated with the financial account.

11. The system of claim 9, wherein the financial account is associated with a deal provider that provides a deal corresponding to the one or more deal redemptions.

12. The system of claim 8, wherein the payee is a merchant corresponding to the merchant identifier.

13. The system of claim 8, wherein the payee is an entity related to a deal corresponding to the one or more deal redemptions.

14. The system of claim 13, wherein the entity is at least one of a distributor, a retailer, and a manufacturer.
